(19) United States
(12) Patent Application Publication
(10) Pub. No.: US 2004/0239965 A1
(43) Pub. Date: Dec. 2, 2004

(54) Systems and methods for generating source color space interpretations

(75) Inventors: Sharon A. Krueger, Penfield, NY (US); Terry L. Stewart, Torrance, CA (US)

Correspondence Address: OLIFF & BERRIDGE, PLC., P.O. BOX 19928, ALEXANDRIA, VA, 22320, US

(73) Assignee: XEROX CORPORATION, Stamford, CT

(21) Appl. No.: 10/448,071

(22) Filed: May 30, 2003

(51) Int. Cl. H04N 1/50; G06F 17/00

(52) U.S. Cl. 358/1.9; 715/911

(57) ABSTRACT

Systems and methods are disclosed for enabling page description language (PDL) specified image processing files to be overridden by a user/operator of a digital color copier/printer at raster input scanning time on a job or page basis. A user can specify an input color space profile that is unspecified or when to override a specified input color space profile for desired results. This allows a user to identify treatment of source data in a file, as well as to override embedded ICC profiles. A precedence model is used to determine which source profile to use among a number of possible source profile sources, including queue, job, page and object sources.

### BACKGROUND OF THE INVENTION

1. Field of Invention

This invention relates to systems and methods for controlling color reproduction of images.

2. Description of Related Art

In general, color processing is a two-step process. Input data in a device-dependent color space is translated into device-independent data, which is in turn translated to a device-dependent color space that is appropriate for an output device, such as an image output terminal (IOT), such as, for example, a marking engine/printer that is used to generate an image according to the input data.

Often, to interpret source color data properly, digital copiers and/or printers tag the color source data within a document file created using a page description language (PDL), translate the source color space data before the data is written to the document file using the page description language, or embed an International Color Consortium (ICC) source profile within the document written using the page description language, where the ICC source profile may be interpreted downstream to translate the source color space data into device-independent color space. These techniques all take place before a page description language is created. In general, there is no easy way to change data within a page description language after it is created.

U.S. Pat. No. 5,687,303, which is incorporated herein by reference in its entirety, discloses a digital color copier/printer and method for creating, decomposing and outputting a page image to a print engine which allows for the printing characteristics of individual objects to be optimized. Page images may be created using page description languages. The systems and methods disclosed in the 303 patent convert a page image defined using a page description language or the like into print data and printer control commands so that each type of object in the page is optimally printed. The 303 patent also discloses object-optimized printer control systems and methods that allow a creator of a page image using a page description language to explicitly override or adjust automatically-determined object types.

The 303 patent also discloses systems and methods for editing and/or processing a page image which keeps object information so that the information may be edited object-by-object at the printer, without the need to create a modified page description language and re-convert it. The 303 patent also discloses systems and methods that allow a user to make minor adjustments in one or more color space transform(s), one or more tone reproduction curve(s) and/or one or more other factors without having to return to the original undecomposed page description language document file.

U.S. Pat. Nos. 6,006,013, 6,256,104, 6,327,043 and 6,429,948, and pending U.S. patent application Ser. No. 09/778,761, filed Feb. 8, 2001, each of which is incorporated herein by reference in its entirety, disclose digital color copiers/printers and methods that create, decompose and output a page image to a print engine and that allow for the printing characteristics of individual objects to be optimized. The 043 patent, when dealing with rendering-related document changes, enters rendering changes to individual objects on a page, such as modifications to the midtone cyan separation of a particular pictorial object on a page, at the printer. This allows for avoiding the need to create a new page description language version of the document.

### SUMMARY OF THE INVENTION

It may be desirable to permit users of color image output systems, such as, for example, digital color reproduction devices, digital color copiers, digital printers, laser printers and other image forming devices, to make adjustments to color attributes, such as, for example, source color space attributes and data, without the need to create a new page description language file.

It may be desirable to be able to reconcile source color space attributes of an image which are imposed on a digital image color reproduction devices on a job, queue and/or page description language basis without the need to create a new page description language file.

This invention provides systems and methods that allow a user to specify how device-dependent color input data is to be treated.

This invention separately provides systems and methods that allow a user to override previously specified treatments that are to be applied to device-dependent color input data.

This invention separately provides systems and methods that allow a user to override previously specified treatments and/or specify treatments to be applied to device-dependent color input data when creating a print job.

This invention separately provides systems and methods that allow color space conversion data in an image data file defined in a page description language to be overridden without having to change the image data file.

This invention separately provides systems and methods that allow a specified color space conversion to be used when a color space conversion for device-dependent color input data that is present in an image data file has not been defined.

This invention separately provides systems and methods that allow color space conversions to be specified in a print job on a page-by-page basis.

This invention separately provides systems and methods that allow color space conversions to be specified in a print job on an object-by-object basis.

This invention separately provides systems and methods that allow color space conversions to be specified in a print job on a page-by-page and object type-by-object type basis.

This invention separately provides systems and methods that provide options available for RGB, CMYK, CMY, gray, and any other device spaces.

This invention separately provides systems and methods that allow a user to specify how device-dependent color input is to be treated at job programming time, such as, for example, at a client location.

This invention separately provides systems and methods that allow a user to specify how device-dependent color input is to be treated at the digital color copier/printer controller.

This invention separately provides systems and methods that allow source color space attributes selected by a user to be carried along with a job on a page-by-page basis.

This invention separately provides systems and methods that use a precedence model to determine which source selected values to use.

This invention separately provides systems and methods that allow source selected values to be applied on an object basis.

In various exemplary embodiments of the systems and methods according to this invention, source selection provides a user the opportunity to change the way data in a page description language may be treated without recreating the page description language. In various exemplary embodiments, the changes that can be made using the systems and methods according to this invention include, for example, substituting an entire color space transform for one which is in the page description language.

In various exemplary embodiments, the systems and methods according to this invention may be used when one or more source color profiles are embedded in an existing file that is defined using a page description language.

In various exemplary embodiments, the systems and methods of this invention may be used in situations where one or more source profiles embedded in a document file have changed.

In various exemplary embodiments, the systems and methods according to this invention may be used when different treatment of device-dependent source data in an existing file that is defined using a page description language is desired by a user.

These and other features and advantages of this invention are described in, or are apparent from, the following detailed description of various exemplary embodiments of the systems and methods according to this invention.

### BRIEF DESCRIPTION OF THE DRAWINGS

The following detailed description of various exemplary embodiments of the systems and methods according to this invention is provided, with reference to the accompanying drawings, in which:

FIG. 1 is a functional block diagram of an exemplary embodiment of a digital image processing system according to this invention;

FIG. 2 is a diagram of a plurality of color source code conversion or transformation paths made available in an exemplary embodiment according to this invention; and

FIG. 3 is a flowchart outlining an exemplary embodiment of a method of specifying source color space interpretations according to this invention.

### DETAILED DESCRIPTION OF EXEMPLARY EMBODIMENTS

As may be discussed in further detail, improved color management is accomplished, in part, by incorporating additional attributes affecting color processing, referred to herein as color-related attributes, into an existing set of job programming attributes available for selection on a job basis, a page-exception basis or a queue basis when configuring and submitting a print job. A list of attributes that can affect the color processing of a print job is found in copending U.S. patent applications Ser. Nos. 10/021,034 and 10/021,035, each of which is incorporated herein by reference in its entirety. Many of those attributes are available for programming on a queue basis, a job basis and a page basis. Some of the color-related attributes listed in the 034 and 035 patent applications are briefly explained below.

RGB Source, CMYK Source, CMY Source and Device Gray Source attributes are examples of source selection attributes. Source selection attributes include those attributes directed to input color space transformation profiles. There are a number of different formats in which an image and the color space transformation of that image may be represented. One specific type of format is defined by the International Color Consortium (ICC). As discussed below, various exemplary embodiments of the systems and methods according to this invention optionally implement the ICC paradigm. To this end, the source selection attributes, when specified, may identify an ICC source profile defining the behaviors of the source on which the color data was created for use in translating device-dependent color data into profile connection space (PCS).

In various exemplary embodiments, the source selection attributes include: RGB Source, CMYK Source, CMY Source, Device Gray Source, or any other Source Space attributes. The value for each of these attributes can be unspecified, or a specific ICC source profile may be specified for use. With the value unspecified, a default ICC profile is used. That is, selecting a specific ICC source profile will allow input source interpretation based on the selected profile. When assigning a value to the attributes, a user is beneficially provided with a list of the source profiles. In various exemplary embodiments, each installed source profile has an associated symbolic name. A list of the symbolic names is made available for queue, page-exception and job programming of source profiles. This list of symbolic names identifying the currently available profiles may be made available for page programming and job programming regardless of where the programming is performed (e.g., locally or remotely).

Furthermore, for each of the attributes, various exemplary embodiments of the systems and methods according to this invention may allow a source profile to be associated with specific object types. That is, a user has the ability to specify either (1) an ICC source profile to use for all objects types on the page or (2) separate ICC profiles for use with one or more of text objects, graphics objects and/or image objects. For example, a user can assign one source profile to image objects and a second source profile to text and graphics objects. Similarly, a user can assign one source profile to image objects, a second source profile to text objects and a third source profile to graphics objects. Moreover, various exemplary embodiments of the systems and methods according to this invention allow options for each of the source profiles to be selected independently. This enables pages with objects in different device color spaces to be interpreted according to the user selection.

Explicit job programming of the source profiles provides a user with the ability to specify the interpretation of “undefined” device-dependent color data in the user's document. Here, “undefined” device-dependent source space means that the page description language file does not contain any specification that indicates the transformation to be used to convert the device-dependent source space into a device-independent source space. This is useful in the situation where a user has a file that contains no information about the source color data, but is aware that the images in the file were obtained from a known scanner. Upon programming the job to use the source profile for this scanner, the “undefined” source color data within the file may be interpreted appropriately. Whenever an “undefined” color space is encountered, a controller may use the source selection values specified by a user to interpret color data.

It should be appreciated that a variety of job attributes, including media attributes, rendering intent, and emulation can affect the output color quality. For example, different color adjustments are appropriate when processing a job to be printed on white paper with a gloss coating as compared to off-white paper with no coating. These adjustments may be accounted for by characterizing each individual media for the supported print engine. Such characterizations can be stored in the form of International Color Consortium (ICC) profiles. Additionally, each object type, such as, for example, images, graphics, text and the like, may have a different rendering intent, such as, for example, color interpretation and gamut mapping, which may be included in the ICC profile. As discussed below, various exemplary embodiments of the systems and methods according to this invention consider these factors and identify the appropriate ICC destination profile to use. In this regard, when the value of the destination profile attribute is “system specified”, the appropriate destination profile is identified as described above. Alternatively, selecting a specific ICC profile with the destination profile selection attributes allows the system selection to be overridden and the color space transformation to be performed in accordance with the selected profile.

The color space adjustment attributes that can be set on a page basis, a job basis and a queue basis include one or more of lightness, contrast, color cast, and saturation, as well as any other appropriate color space adjustment attributes. In various exemplary embodiments, a user is able to independently select specific adjustments for each color space adjustment attribute.

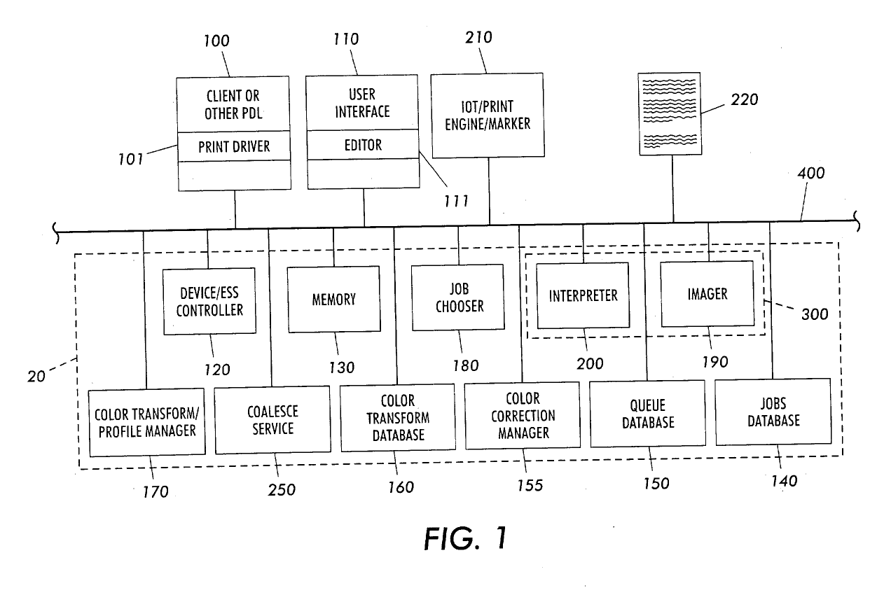

FIG. 1 shows an exemplary embodiment of a digital imaging system 10 that incorporates color management systems and methods according to this invention. The digital imaging system 10 includes a client 100, an image processing system 20 and an image output terminal/print engine/marker 210. The client (and/or other page description language file source) 100 operates as a source of the image data to be rendered and output onto suitable media. The image processing system 20 includes a digital front end (DFE) that processes digital image data received from the client 100 and converts the image data into binary print ready data that is supplied to an image output terminal/print engine/marker 210. In response to the print ready data, the image output terminal/print engine/marker 210 generates an output document 220 on suitable media. The systems and methods described herein may be used to provide improved color management capabilities within an image processing system, such as that which is known in the art as a digital front end or DFE. In particular, the systems and methods described herein are directed to providing automatic color processing aimed at a novice color user while providing specific control of the parameters in the color management path for skilled users. To achieve the improved color management capabilities, a digital front end incorporating features described below allows a user to select different color processing options to be applied on a per-page basis. In furtherance of this feature of offering color controls on a per-page basis, the digital front end also allows color output processing options to be identified for each side of the media. In addition, a digital front end incorporating features described herein, allow color-rendering options to be selected based on non-color job programming attributes.

As shown in FIG. 1, the client 100 may comprise a computer, a scanner or any similar or equivalent image input terminal (image source) and further may include one or more applications, drivers and operating systems that facilitate providing digital image data, which may comprise any combination of grayscale data, ASCII text characters, bitmap or bytemap images, graphic primitives, high level graphics or page description language, such as PostScript.RTM or the like. The client 100 further includes a print driver 101 or similar tool for compiling job programming attributes, including color attributes, and assembling the attributes and image data into a print job, for example, that may be forwarded to and stored in a print job database 140.

The print driver 101 is accessible to a user via a graphical user interface (GUI) 110, which may include an editor 111. The graphical user interface 110 provides an interface that enables a user to select and communicate job programming attributes to the image processing system 20. Job programming attributes describe selected parameters by which the a print job may be processed and can include parameters for page layout (e.g., size, orientation, duplex), color options (e.g., brightness, contrast, saturation), media type, finishing options (e.g., output tray, collate, staple, binding), and the like. In addition to selecting parameters for the print job, the graphical user interface 110 and the print driver 101 can be used to set additional or alternate job attributes on a per-page basis for selected pages. These special attributes to be used for selected pages within a job are often referred to as page exceptions. Similarly, the ability to set different attributes on a per-page basis is sometimes referred to as page-exception programming.

In addition to setting additional or alternate job attributes on a per page basis, the graphical user interface 110 and the print driver 101 can be used to set color space conversions for a print job on an object-by-object basis, as in the aforementioned 013, 104, 043, 948 and 761 patents. Such objects include, but are not limited to, text portions, constant color portions, sampled color portions, and image portions of a page.

The use of print drivers to compile job programming attributes and page exceptions is well known in the field of digital printing. In accordance with the color management features of the systems and methods according to this invention, the image processing system 20 extends the attributes available for both job and page-exception programming to those color-related attributes available on a job and per-page basis. The image processing system 20 will process a print job according to the programmed job attributes and will process each page exception within the print job according to the page-exception programming therein.

The image processing system 20 includes one or more print queues for receiving input data such a print job. Each print queue is configured with a set of queue attributes. The queue attributes provide a set of processing parameters in the same manner as job attributes. Specifically, in various embodiments of the systems and methods according to this invention, the queue attributes identified, for example, in the incorporated 034 and 035 patent applications, can be programmed by a system administrator or similar user. Furthermore, in addition to an attribute value, each queue attribute set on the print queue can be independently assigned a queue qualification of either “override” or “default.” The value of the queue qualification is used to determine precedence when reconciling job attributes and queue attributes. In this manner, each print queue can be thought of as a virtual printer wherein sending a print job to a print queue picks up attributes of that print queue.

The image processing system 20 further includes a job chooser 24 which retrieves print jobs from print queues, for example, that are forwarded to and stored in a print queue database 150, and reconciles the color attributes set at the client 100 with the color attributes associated with the print queue to which the job was submitted, thereby generating a set of reconciled attributes. After reconciling the attributes, the job chooser 180 passes the print job and reconciled attributes to a decomposer 300. At the end of the reconciliation operation, each color related attribute will have a qualification of either “override” or “default”.

The decomposer 300 receives the resolved print job from the job chooser 180 and processes the received image data therein to produce print ready data (which may be binary or contone data) that is supplied to the image output terminal/print engine marker 210. In response to print ready data, image output terminal/print engine/marker 210 generates the output document 220 on suitable media. The image output terminal/print engine/marker 210 is preferably an electrophotographic engine; however, the image output terminal/print engine/marker 210 may include such equivalent alternatives as ink jet, ionographic, thermal, and the like devices/systems.

More specifically, the decomposer 300 includes an imaging manager/imager 190, which may comprise what is generally known in the art as an interpreter 200 and an imager 190, to reconcile the reconciled attributes from the job chooser 180 with any attributes embedded in the page description language image data (“internal” qualification) to generate a set of final attributes. The reconciliation of the attributes may be based on a precedence model, as described below. Given the final set of attributes, the imaging manager/imager 190 identifies the source profile and the destination profile to use for color space transformation.

The interpreter 200 is a page description language interpreter which receives a page description language document from the job chooser 180. The interpreter 200 then parses the page description language stream into various image related components that are subsequently stored in the print job database 140 and later referenced using identifiers. The identifiers of job components are passed from the interpreter 200 to a coalesce service 250 for font processing and bitmap processing. Coalesced information is then imaged by the imager 190 to bits which are transmitted to the image output terminal/print engine/marker 210 to be rendered, for example, on paper. Additionally, coalesced information in the print job database 140 can be edited using the editor 111 through the graphical user interface 101 prior to transmission to image output terminal/print engine/marker 210.

Upon receipt, the interpreter 200 of page description language the decomposer 300 parses the image primitives of the page description language stream arriving through interface 400. Each image primitive is stored in the print job database 140 before being imaged to bits by the imager 190. Some of the image primitives parsed are modified or overridden by the interpreter 200 without re-creating the page description language file.

The selected color defines the color that the interpreter 200 stores in the print job database 140. Once a page description language stream of image data has been parsed by the interpreter 200, and the page description language stream's image components have been stored and referenced using identifiers in the print job database 140, the identifiers of job components are passed from the interpreter 200 to the coalesce service 250 for font processing and bitmap processing. Coalesced information is then imaged by the imager 190 to bits which are transmitted to the image output terminal/print engine/marker 210 to be rendered, for example, on a page. The page description language does not have to be re-written to accomplish this rendering of color information.

It will no doubt be appreciated that in a printing architecture as described above which separates the processing into a page description language decomposition stage (e.g., the interpreter 200 and the coalesce service 250) and an imaging stage (e.g., the imager 190), colors of image elements are usually found at the interface between these two stages. Accordingly, in an alternate embodiment, the color rendering may be carried out in the imager 190. According to the systems and methods of this invention, however, color source attributes do not have to be re-inserted into the page description language to be rendered. Also, invocation of the color source attributes depends upon the interface between the user's application and the printing system. Thus, in alternate embodiments, there may not exist an a priori way of determining whether or not changing the color source attributes is desirable, and consequently a printer may be configured such that all color attributes are determined by default.

The imager 190, using an appropriate source profile, translates the image data from the input color space into a common device-independent color space, for example, profile connection space (PCS). Once in the device-independent color space, the imager 190 operates on the data to perform any color adjustments requested in the final attributes. The image data is then translated into device-dependent color space data, for example, CMYK data, via information in the appropriate destination profile. Once in the device-dependent color space, the imager 190 performs any requested control operations, such as, for example, trapping, anti-aliasing, halftoning, black overprint, and the like. To perform the color space transformations, the imager 190 obtains selected attributes from the set of final attributes and builds a transformation query. The transformation query is passed to a color profile manager (CPM) 170 which retrieves the appropriate ICC profile from a color transform/profile database 160. To support the color profile manager 170 and the profile database 160, the image processing system 20 includes a color collection manager (CCM) 155.

Color collection manager 155 maintains the color transform/profile database 160 which comprises two types of records: profile records (i.e., ICC source and destination profiles) and profile assignment records. Specifically, color collection manager 155 operates to create, modify, obtain and/or delete profile records. The color collection manager 155 may beneficially include an associated graphical user interface, such as the user interface 111, that enables a user to perform the create, modify, obtain and/or delete operations. Assignment records exist for destination profiles only and are used to associate an ICC destination profile with media attributes and emulation attributes.

The following fields may be used to define the structure of an ICC destination profile assignment record: Profile Name, symbolic name assigned to the ICC profile; Media Name, symbolic stock name identifying a specific media; Color, stock color; Weight, stock weight; Coating (F/B), coating of the media (front/back sides); White Point (F/B), media white point (front/back sides); and Opacity, stock opacity.

It is through the use of the fields in the assignment records that the color profile manager 170 identifies and retrieves the appropriate ICC destination profile for color space transformation. Each ICC destination profile need not will have an assignment record associated therewith (i.e., referencing the profile). In such an instance, the destination profiles may be used when the value of destination attribute specifically names the destination profile (i.e., something other than “system specified” or unspecified).

Optionally, the profile data base includes one assignment record for each named media/stock supported by the digital front end. It should be appreciated that there may be more than one assignment record a for each destination profile. That is, different named media may have similar (or even the same) attributes and thus may use the same destination profile. Likewise, a specific stock may have more than one assignment record and more than one destination profile associated therewith. This may be accomplished through the use of different symbolic media names mapped to the same specific stock, as each assignment record should be unique.

A single document, or set of data, may include only data created at a single source, or may include data from more than one data source. For example, a single document may contain a scanned image, text, and/or a graphic, each created at a different source.

The image output terminal/print engine/marker 210 may be set to emulate another output device, and the specified emulation may be used as an output parameter. As another example, various rendering intents may be specified, and the specified rendering intent may be used as an output parameter. Examples of rendering intents include “perceptual,” “saturation,” “absolute colorimetric,” and “relative colorimetric”, all specified by the International Color Consortium (ICC), and “pure,” specified by Xerox Corporation in, for example, the Color Encoding Standard, Xerox System Integration Standard, Xerox Corp, Palo Alto, Calif., July 1991, XNSS 289107 (“The Xerox Color Encoding Standard”), which provides a standard for interchanging electronic color documents among document applications and devices. The Xerox Color Encoding Standard describes three reference color systems that attempt to provide device independent color between devices such as workstations and printers. All references cited in this specification, and their references, are incorporated by reference herein where appropriate for appropriate teachings of additional or alternative details, features, and/or technical. As is known by those skilled in the art, each rendering intent specifies an enhancement used for a particular context. For example, “perceptual” makes photograph images more life-like, “saturation” makes colors brighter and is useful to enhance the look of pie charts, and so forth.

It should also be appreciated that in various exemplary embodiments of the systems and methods according to this invention, different sets of output parameters may be specified for different parts of the same page. For example, in various exemplary embodiments, different rendering intents may be specified for different parts of the same document. Moreover, in various exemplary embodiments, if a document contains a photographic image, a pie chart, and text, the “perceptual” rendering intent may be specified for the photographic image portion of the data, the “saturation” rendering intent may be specified for the pie chart portion of the data, and the “pure” rendering intent may be specified for the text portion of the data.

In various exemplary embodiments according to this invention, proof prints may be made and printing jobs may be processed in accordance with printing instructions that are based on the proof prints. Each of the printing jobs may comprises one or more pages of hard copy document originals. In various exemplary embodiments of this invention, digital image color reproduction devices may be programmed with printing instructions for each printing job. Original pages that comprise each job may be scanned and converted to electronic pages. The electronic pages of each job may be combined with the printing instructions for the job to provide a job file for each of the jobs. The job files may be stored in memory pending printing. To print job files, a print queue may be formed with the jobs in a preset printing priority for successive accessing of the print files to be printed. For proof prints, the job file succession in the print queue may be interrupted to insert the job file for printing the proof prints at the earliest opportunity. Upon detecting proof prints. The printer interrupts the job currently being printed, reprogramming the printer with the printing instructions from the job file for the proof prints. Then, using the job file, proof prints of the electronic pages of the proof prints are made. The interrupted job file is detected as printing of the proof prints is ending. Then the printer is reprogrammed with the printing instructions from the job file for the interrupted job, and printing of the interrupted job is resumed.

Various exemplary embodiments of the systems and methods according to this invention include a user input device to allow users to set various output and/or input parameters. Still, the systems and methods according to this invention may also include an option of operating at default values when the user does not specify output and/or input parameters. This allows an experienced user the flexibility to input and/or modify parameters as desired to obtain optimal or desired results, while allowing a novice user to obtain good results even without extensive knowledge or skill.

The image processing system 20 may be a separate device from, or integrated with the other elements of the digital reproduction device that is capable of producing a hard copy image output. Furthermore, the image processing system 20 may be implemented as software. Other configurations of the elements shown in FIG. 1 may be used without departing from the spirit and scope of this invention.

The decomposer 300 may include plural interpreters 200, any of which may analyze page description language files. Examples of known page description languages include PostScript, TIFF, PDF and PCL (e.g., PCL5C and PCL5E). Thus, for example, one interpreter may be a PostScript interpreter, a second interpreter may be a TIFF interpreter, a third interpreter may be a PDF interpreter, and a fourth interpreter may be a PCL interpreter.

Color source profiles define the characteristics of the source format in which data was created, and are used to translate device-dependent data, i.e., data in the format in which it was created, into device-independent data. Known examples of source profiles include source ICC profiles (defined by the International Color Consortium), including both input ICC profiles and display ICC profiles. ICC profiles are applicable for PDF and TIFF, for example. Other known examples of source profiles are color space dictionaries (CSDs), which are a resource available for PostScript. Other known examples of source profiles are configure image data (CIDs), which are a resource available for PCL5C, for example.

In addition, source profiles may simply refer to the color space in which data was created, or may, for further detail, include additional information about individual sources, such as characteristics particular to certain manufacturers or models, for example. In short, any set of information that can be used to translate device-dependent data into a device-independent color space may be used as a source profile. Thus, other known or later developed source profiles are applicable and are within the scope of this invention.

The device-independent color space into which data is converted based on source profiles may be any known device-independent color space, such as CIELAB or XYZ, or any later developed space. The profile connection space (PCS), defined by the ICC, is similar to the CIELAB color space, and is defined in terms of the colorimetry that will produce the desired color appearance if rendered on a reference imaging medium and viewed in a reference viewing environment.

The destination profiles are used to convert device-independent space data to device-dependent data targeted for a specific destination or device, e.g., printer, display, etc., at which the data is to be output, either directly or at some future time after being indefinitely stored. Known examples of the destination profiles include destination ICC profiles, also known as output ICC profiles. Other known examples of the destination profiles are color rendering dictionaries, which are a resource available for PostScript. In short, any set of information that can be used to translate a device-independent color data into a device-dependent color space may be used as a destination profile. Thus, other known or later developed destination profiles are applicable and are within the scope of this invention.

Calibration tone reproduction curves may be provided for self-calibration of a destination device such as a marking engine, for example, in accordance with known calibration methods.

The decomposer 300 may also include a profile information extractor (not shown) to determine whether any profile information is embedded within the incoming data. The profile information may be in the form of one or more complete source profiles and/or one or more complete destination profiles. Alternatively, rather than complete profiles, pointers to profiles may be included. For example, rather than including a complete source profile and/or a complete destination profile, the data may include a pointer to a source profile in the color profile manager 170, and/or a pointer to a destination profile in the color profile manager 170. In this case, the appropriate profile or profiles may be retrieved from the color profile manager 170.

If source profile information is not included in the incoming data, the user may, if the user knows the source format of the incoming data, input profile information via the user input device 110. Alternatively, a “sniffer” (not shown) may be provided that analyzes the incoming data to determine the source format of the incoming data. If the source format is not known and cannot be determined, the image processing system 20 may process the data without the source profile information. For example, the image processing system 20 may use default values, prompt the user to input a best guess, or the like.

If color adjustments in the form of lightness, contrast, saturation, color cast or the like are requested by a user via the user input device 110, or if a color adjustment request is included with incoming data, the color adjustments are performed by the decomposer 300.

In addition to the functions described above, the controller 120 performs any other control needed to control the flow of data and the operations of the other components within the image processing system 20.

The memory 130 may store any programs needed for operation of the image processing system 20, and may, if necessary, serve as a buffer during input or output of data to or from the image processing system 20, and/or during processing of the data within the image processing system 20.

It should be appreciated that, if incoming data is already in the proper output format, no data conversion needs to be performed. Thus, the decomposer 300 may simply detect that the input format and the requested output format are identical and direct the information directly to the appropriate image output terminal/print engine/marker 210.

The memory 130 shown in FIG. 1 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-writeable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

It should be understood that each of the elements shown in FIG. 1 can be implemented as portions of a suitably programmed general purpose computer, special purpose computer, microprocessor or the like. For example, the circuits can be implemented as software executing on a programmed general purpose computer, a special purpose computer, a microprocessor or the like. In this case, the image processing system 20, or any of its components, can be implemented as a routine embedded in a printer driver, as a resource residing on a server, or the like. The image processing system 20 can also be implemented by physically incorporating it into a software and/or hardware system, such as the hardware and software systems of a printer or a digital photocopier. Alternatively, each of the elements shown in FIG. 1 can be implemented as physically distinct hardware circuits within an ASIC, or using a FPGA, a PLD, a PLA or a PAL, or using discrete logic elements or discrete circuit elements. The particular form each of the circuits shown in FIG. 1 will take is a design choice and may be obvious and predictable to those skilled in the art.

The systems and methods according to this invention reconcile color control attributes set on the job by a user with input color space attributes on the queue to which the job was submitted. At the end of the reconciliation, each attribute will have a qualification of either an “override” or a “default.” The data flow of the reconciliation may proceed as follows. The queue and job reconciled color space control attributes are placed on a file decomposer task. The user input color space control attributes are then reconciled with the attributed embedded in the page description language attributes, which are considered to be of “internal” qualification, by the decomposer. A color imager, which may be part of a controller, given the necessary color space control attributes for color space transformation selection, may query a color profile manager, which may then consult a database to locate the proper color space transformation.

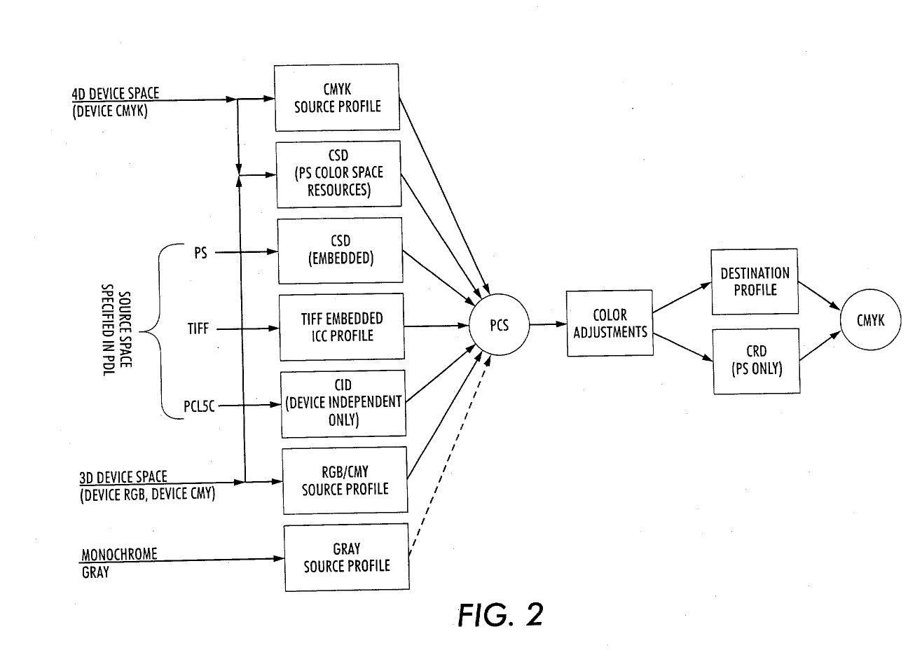

FIG. 2 illustrates numerous exemplary paths through a digital reproduction device which may be supported to enable a suitable number of source color management selections that are to be available to a user. A user may determine which of the paths shown in FIG. 2 to follow, whereas the precedence to be followed may be based on a precedence model. One exemplary order of precedence in selecting which color space control attributes are used to achieve proper color transformation is that any client or job programmed parameter takes precedence over the page description language corresponding parameter. In this exemplary embodiment, any color processing programmed in a job ticket, such as, for example, color rendering intent or input data source, may be followed. But, if color processing commands are not contained in a job ticket, the page description language processing commands may be used. In this exemplary embodiment, when no image processing information is present in the job ticket or the page description language, queue defaults may be followed and implemented.

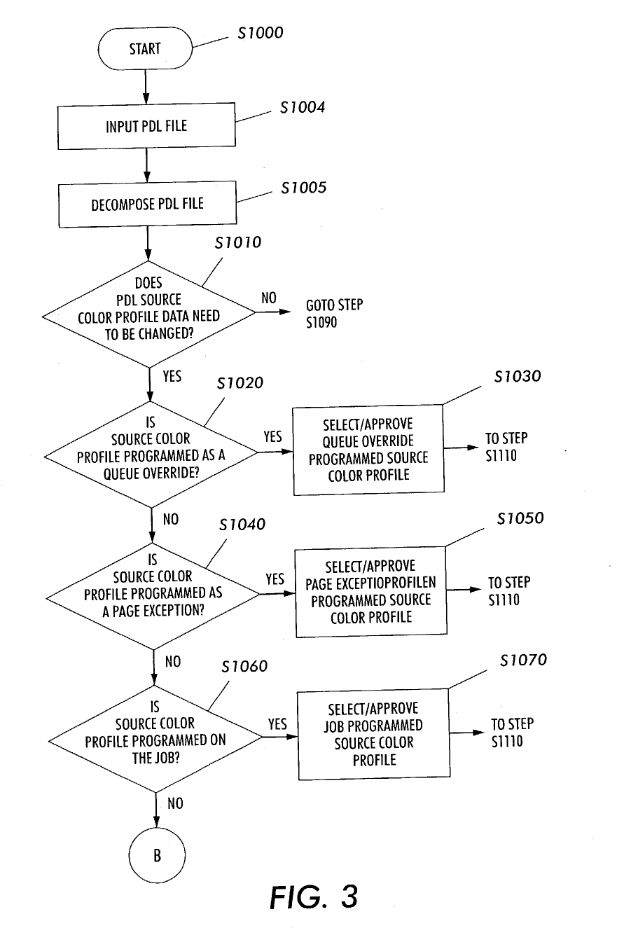

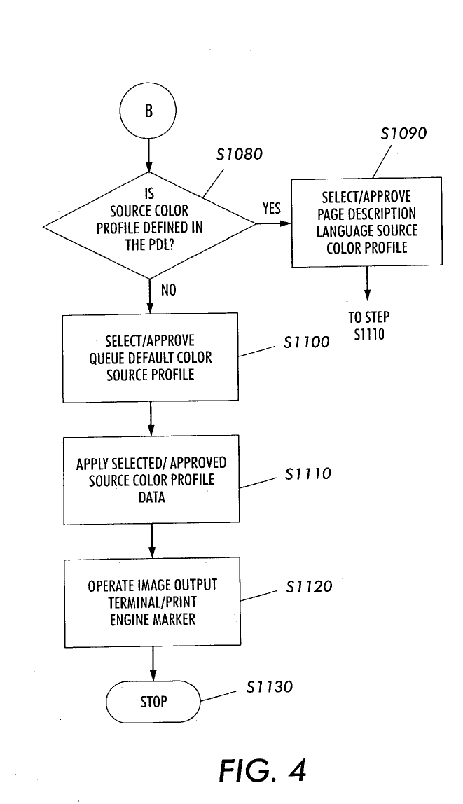

FIG. 3 is a flowchart outlining one exemplary embodiment of a method for converting data formats according to this invention. Beginning in step S1000, where the process starts, control proceeds to step S1004, where a file is input in page description format, control continues to step S1005, where the page description language file is decomposed. Control then continues to step S1010.

In step S1010, a determination is made whether the decomposed page description language source color profile needs to be adjusted or otherwise changed. This determination is typically based on a number of factors. The color source profile in the page description language may be incomplete, or a user may have indicated a desire to change the, or have provided a different, source color profile in the page description language, or a job profile or a queue profile may differ from the page description language source color profile. For example, a situation may occur in which some source profile information is available, but the available source profile information is insufficient. This situation may occur, for example, if the user has made an error in inputting source profile information. The method could proceed from this point based on a default setting. However, if a user has input (or attempted to input) some source profile information, it may be assumed that the user is aware of information relevant to the source profile, and desires to input this information. Therefore, a user may be prompted for further input. This prompt may, for example, be in the form of a text message or pop-up window displaying a message to the effect of “The source profile information is insufficient. Please input source profile information again.” The user is thus given a further opportunity to input the source profile information.

If the page description language source color profile does not need to be adjusted, changed or redefined, control jumps to step S1090, where the page description language source color profile is approved. As an alternative, control could jump directly to step S1120 where the image output terminal/print engine marker is operated based on the applied source color space conversion. Because the source data is already in the output space of the print engine it needs no conversion.

In step S1020, a determination is made whether the source color profile is programmed as a queue override. If not, control continues to step S11040, where it is determined if the source color profile has been programmed as a page color exception. If, however, the source color profile has been programmed as a queue override, control proceeds to step S1030 whereupon the source color profile programmed as a queue override is selected. Then, control proceeds to step S1110 to activate the color conversion called for in the user defined source color space and to apply the source color space conversion to the image output terminal/print engine marker. Then, in step S1120, the image output terminal/print engine marker is operated based on the applied source color space conversion. If, in step S1040, control determines that the source color profile has been programmed as a page exception, then control proceeds to step S1050, whereupon the source color profile programmed as a page exception is selected. If not, control proceeds to step S1060 and determines whether the source color profile has been programmed on the job. If so, control proceeds to step S1070, whereupon the source color profile programmed on the job is selected/accepted. If not, control moves to step S1080 and a determination is made whether there is a source color profile defined in the page description language (PDL). If so, control proceeds to step S1090, whereupon the source color profile defined in the page description language is selected/accepted. If not, control proceeds to step S11100 where the queue default source color profile is selected/accepted. After a source color profile is selected, in one of steps S1030, S1050, S1070, S1090 and S1100, control proceeds to step S1110 to apply the selected/accepted source color code to the image output terminal. Then control proceeds to step S1120, where the image output terminal/print engine marker is operated using the selected/accepted source color code. Then, control ends in step S1130.

A mechanism may be provided to allow a trusted user or system administrator to load any of the aforementioned profiles, including custom profiles onto the controller. A user may have access to these loaded profiles and the ability to choose specific profiles on a job, page and queue basis.

A complete source profile may be obtained from a database or other data storage device or software structure based on a pointer or other appropriate source profile information.

The aforementioned exemplary method may be performed for each object on each page, and the source profile may be varied for each object or a single object, e.g., an image, a graphic, and/or text, in a page. One or more object source profiles may be used, depending on the characteristics of the digital color copier/printer.

A user can set up color space control attributes on a job basis, and/or a queue basis and/or a page basis and/or an object basis. If different color space control attributes are set on a given print job and on a queue to which a job is submitted, these different color space attributes are reconciled. At the end of reconciliation, each attribute will have a qualification of either “override” or “default.”

As indicated above, the color space control attributes embedded in the page description language may be determined, according to the systems and methods of this invention, to be of “internal” qualification by the decomposer, and overridden of there are user input color space control attributes. As described above, the order of precedence in selecting which color space control attributes are used to achieve proper color transformation may be that any client or job programmed parameter takes precedence over the page description language corresponding parameter.

Various exemplary embodiments of the systems and methods according to this invention include the setting of one or mode orders of precedence of operation of the digital color printer/copier.

Once the necessary color space control attributes are selected based on the aforementioned order of precedence, the proper transformation is obtained from a database or other source.

While particular exemplary embodiments of this invention have been described in conjunction with the exemplary embodiments outlined above, it is evident that many other alternatives, modifications, variations and improvements and substantial equivalents that are or may be presently unforeseen may arise to applicants or others skilled in the art. Accordingly, the exemplary embodiments of the invention, as set forth above, are intended to be illustrative and not limiting. Various changes may be made without departing from the spirit and scope of the invention.

What is claimed is:

1. A method of treating input device-dependent color profile attributes or data of an image, comprising:
determining device-dependent source color profile data attributes of the image in a page description language; and
prioritizing a plurality of different source profile attributes to override a page description language source color profile.

2. The method of claim 1, further comprising:
specifying the device-dependent source color profile data attributes on at least one of a queue, job, page and object basis to control an image output terminal without re-writing page description language source color attributes.

3. The method of claim 2, wherein specifying the device-dependent color profile attributes in other than a page description language is done on a queue basis.

4. The method of claim 3, wherein specifying the device-dependent color profile attributes in other than a page description language is done on a job basis.

5. The method of claim 2, wherein overriding existing page description language attributes comprises using job profile data attributes to override the page description language attributes.

6. The method of claim 2, wherein specifying the device-dependent color profile attributes comprises using queue profile data attributes as default source color attributes.

7. The method of claim 2, wherein:
the object basis comprises at least one of text objects, constant color objects, sampled color objects and image objects.

8. A system to treat input device-dependent color profile attributes or data of an image, comprising:
a subsystem to determine device-dependent source color profile data attributes of the image in a page description language; and
a subsystem to prioritize a plurality of different source profile attributes to override a page description language source color profile.

9. The system of claim 8, further comprising:
a subsystem to specify the device-dependent source color profile data attributes on at least one of a queue, job, page and object basis to control an image output terminal without re-writing page description language source color attributes.

10. The system of claim 9, wherein specification of the device-dependent color profile attributes in other than a page description language is done on a queue basis.

11. The system of claim 9, wherein specification of the device-dependent color profile attributes in other than a page description language is done on a job basis.

12. The system of claim 8, wherein overriding existing page description language attributes comprises using job profile data attributes to override the page description language attributes.

13. The system of claim 9, wherein specifying the device-dependent color profile attributes comprises using queue profile data attributes as default source color attributes.

14. The system of claim 9, further comprising a subsystem to prioritize a plurality of different source profile attributes to override a page description language source color profile.

15. The system of claim 9, wherein:
the object basis comprises at least one of text objects, constant color objects, sampled color objects and image objects.
